(19) United States
(12) Patent Application Publication
(10) Pub. No.: US 2005/0080816 A1
(43) Pub. Date: Apr. 14, 2005

(54) Method of, and system for, heurisically determining that an unknown file is harmless by using traffic heuristics

(75) Inventor: Alexander Shipp, Barmwood (GB)

Correspondence Address: NIXON & VANDERHYE, PC, 1100 N GLEBE ROAD, 8TH FLOOR, ARLINGTON, VA, 22201-4714, US

(73) Assignee: MessageLabs Limited, Gloucester (GB)

(21) Appl. No.: 10/500,957

(22) PCT Filed: Mar. 29, 2004
(86) PCT No.: PCT/GB04/01333

(30) Foreign Application Priority Data
Apr. 25, 2003 (GB) 0309463.8

(51) Int. Cl. G06F 7/00

(52) U.S. Cl. 707/104.1

(57) ABSTRACT

A system for processing a computer file to determine whether it contains a virus or other malware maintains a database of known files which it references to determine whether the file is an instance of a known file, and if so, whether it has been known about long enough that it can be regarded as safe. If it can be regarded as safe, the file is subject to less thorough processing for detecting malware, or no such processing at all.

The present invention relates to a method of, and system for, heuristically determining that an unknown file is harmless by using traffic heuristics. This technique is especially applicable to situations where files enter a system, are checked, then leave, such as email gateways or web proxies. However, it is not intended to be limited to those situations.

Increasing use of the Internet, personal computers and local- and wide-area networks has made the problem of viruses and other malware (=malicious software) ever more acute.

There are numerous anti-virus packages available. These tend to be produced by specialist companies and are used by businesses and other organisations, home users, and by some internet service providers (ISPs) who scan e-mail and other network traffic on behalf of their customers as a value-added service. As new viruses and other malware arise, the package creators devise ways of detecting them and dealing with them and issue updates to their packages which customers can utilise. A common practice is to make the updates available for download over the internet, from the creator's website or ftp site.

Most anti-virus packages include a file-scanning engine and a database of characteristics of known viruses which are used by the scanning engine to determine whether a file being scanned is, or contains, a virus or other malware, or is likely to do so. The sort of update mentioned above typically includes an update to this database.

The scanning engine may implement a variety of heuristics to be applied, possibly selectively, to a file being scanned. Probably the most familiar kind of heuristic is signature detection, in which the file is examined for the occurrence of sequences or bytes, or patterns of such sequences, which are known to be characteristic of viruses in the package's virus database, though many other heuristics also exist, which can be used as well as or instead of signature detection.

The amount of malware in existence increases all the time, which makes the computational and storage resources necessary to detect it increasingly burdensome, particularly where the throughput of files is high, as is the case with ISPs.

According to the present invention, there is provided a system for processing a computer file to determine whether it contains a virus or other malware comprising:

a) means for generating data with regard to the file to characterise its identity and for thereby referencing a computer database to determine whether it is an instance of a known file;

b) means for selectively subjecting the file to a number of heuristic procedures to determine whether or not it contains, or is likely to contain, malware; and

c) means for determining, in dependence upon the record, if any, of the file in the database, whether the file can be regarded as safe and for controlling the means b) such that the file, if the file is to be regarded as safe, is either subject to less thorough processing than if it were not so regarded or not subject to processing by the means b) at all.

The invention also provides a method of processing a computer file to determine whether it contains a virus or other malware comprising:

a) generating data with regard to the file to characterize its identity and for thereby referencing a computer database to determine whether it is an instance of a known file;

b) selectively subjecting the file to a number of heuristic procedures to determine whether or not it contains, or is likely to contain, malware; and

c) determining, in dependence upon the record, if any, of the file in the database, whether the file can be regarded as safe and conducting the step b) such that the file, if the file is to be regarded as safe, is either subject to less thorough processing than if it were not so regarded or not subject to processing by the step b) at all.

The invention will be further described by way of non-limitative example with reference to the accompanying drawings, in which:

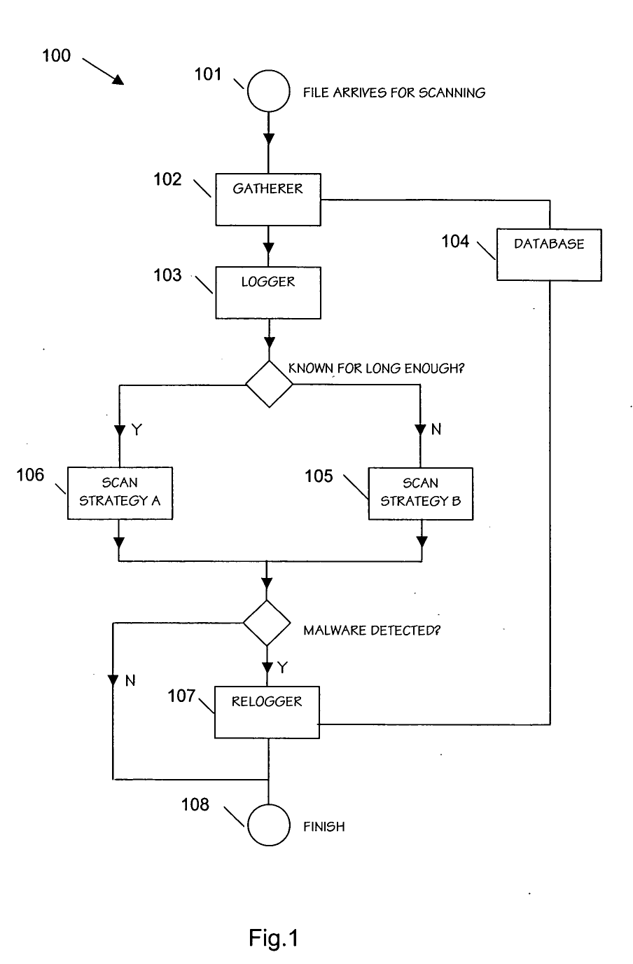

FIG. 1 is a block diagram of a system embodying the present invention.

FIG. 1 illustrates one form of a system 100 according to the present invention, which might be used, for example by an ISP as part of a larger anti-virus scanning system which employs additional scanning methods on files which are not filtered out as “safe” by the system of FIG. 1. Files considered safe can if desired be subject to further processing to check for malware, but less intensively so than files not considered safe.

The rationale of the system 100 is that if a particular file has been scanned by a virus scanner, and found to be harmless the two possibilities exist: The file could really be harmless, or the file could contain something nasty which the virus scanner is as yet unable to detect.

As time goes by, the file (or another instance of it) may be scanned again, and still found to be harmless.

This time the file is more likely to really be harmless, rather than to be malware which the virus scanner is as yet unable to detect. This is because virus scanners are continually updated to detect new malware as the new malware is discovered. The longer the time that passes, the more likely it is that a suspicious person will submit a file containing malware to the developers of the scanner, who will analyse the file, and update their scanner to detect it.

As more and more instances of the file are scanned coming from different sources, then if these are all flagged as harmless, it becomes less and less likely the file is malware. This is because the more copies of a piece of malware exist, the more likely it is that somebody will become suspicious and submit a copy to scanner developers.

It is therefore possible to create a feedback engine which logs copies of files scanned, together with the source they originated from. The log is updated and examined as each file is scanned, and if files are found which have come from a sufficient number of sources, in sufficient quantities, and over a long enough period of time, then that file can be flagged as ‘known about long enough’. This might mean that future copies are then not scanned further, or are scanned using less rigorous scans with fewer heuristics enabled, or are only scanned if the scanner has been updated since the last scan.

The system 100 operates according to the following algorithm:

1) A file arrives at an input 101 for scanning, perhaps as an email attachment, or a web download.

2) A ‘gatherer’ module 102 gathers information about the file, such as a checksum of the file contents and the source of the file (eg the IP address). The source may be passed through a one way trapdoor function, generating a hash, in order to preserve confidentiality. The information gathered is for comparison with information stored in a database 104 about known files so that it can be determined whether the file under consideration is an instance of a file recorded in database 104.

3) Based on the checksum derived by gatherer 102, a ‘logger’ module 103 updates the database 104 to indicate that one more instance of the file has been detected. The logger 103 saves the current ‘last seen’ date as the ‘previously scanned date’, and then updates the ‘last seen’ date of the file's entry in the database 104. If this is the first instance of the file, the logger 103 also updates a ‘first seen’ date. If this is a new source, the logger 103 adds the source to a list, stored in database 104, of sources the file has originated from.

4) From the information stored (number of copies of the file seen, length of time file has been known about, number of sources) the logger 103 calculates whether the file has been ‘known about long enough’. For this purpose, the logger 103 may assign a weighted score to each of these factors individually and then calculate an overall score by combining the weighted scores, e.g. by adding them up.

5) If the file has not been known about long enough, scan strategy B is undertaken at 105. This will be the most complete scan available.

6) If the file has been known about long enough, scan strategy A is undertaken at 106. This will be a less thorough scan than strategy B. This will be site-dependent as to how less thorough a scan is desired. At the extreme it might involve no scanning at all. It might involve scanning with fewer scanners; with heuristics not fully enabled or turned off, or (assuming the file has been seen at least once before) only with scanners that have been updated since the ‘previously scanned date’

The scanning techniques available to the scanning strategies A and B may include any suitable heuristics, such as signature-based scanning, generating checksums from the file or selected regions if it, etc.

7) Following the scan strategy A or B, then if no malware was detected, processing stops at 108.

8) If malware was detected, then a ‘relogger’ module 107 is invoked. This clears out all database entries in database 104 which are associated with the file so that it cannot become ‘known about long enough’ in the future.

9) Processing of the current file finishes at 108, whereupon the system can retrieve the next file from a queue of files waiting to be processed.

1. A system for processing a computer file to determine whether it contains a virus or other malware comprising:
a) means for generating data with regard to the file to characterise its identity and for thereby referencing a computer database to determine whether it is an instance of a known file;
b) means for selectively subjecting the file to a number of heuristic procedures to determine whether or not it contains, or is likely to contain, malware; and
c) means for determining, in dependence upon the record, if any, of the file in the database, whether the file can be regarded as safe and for controlling the means b) such that the file, if the file is to be regarded as safe, is either subject to less thorough processing than if it were not so regarded or not subject to processing by the means b) at all.

2. A system according to claim 1 wherein the controlling means c) controls the means b) in dependence on factors including the length of time for which the database indicates that the file has been known without malware-containing instances of it being detected.

3. A system according to claim 1 or 2 wherein the controlling means c) controls the means b) in dependence on factors including sources, recorded in the database, from which instances of the file have originated.

4. A system according to claim 1, 2 or 3 wherein the controlling means c) controls the means b) in dependence on factors including the number of times, recorded in the database, of instances of the file have been processed.

5. A system according to any one of the preceding claims, and including means for updating the database in dependence upon the result of the processing of the file by the means b).

6. A system according to claim 5 wherein the updating of the database, in the event of the means b) determining that the file contains, or is likely to contain, malware is such that the record thereof in the database is deleted, or updated so that it is no longer taken be safe.

7. A method of processing a computer file to determine whether it contains a virus or other malware comprising:
a) generating data with regard to the file to characterise its identity and for thereby referencing a computer database to determine whether it is an instance of a known file;
b) selectively subjecting the file to a number of heuristic procedures to determine whether or not it contains, or is likely to contain, malware; and
c) determining, in dependence upon the record, if any, of the file in the database, whether the file can be regarded as safe and conducting the step b) such that the file, if the file is to be regarded as safe, is either subject to less thorough processing than if it were not so regarded or not subject to processing by the step b) at all.

8. A method according to claim 7 wherein the determining step c) controls the step b) in dependence on factors including the length of time for which the database indicates that the file has been known without malware-containing instances of it being detected.

9. A method according to claim 7 or 8 wherein the determining step c) controls the step b) in dependence-on factors including sources, recorded in the database, from which instances of the file have originated.

10. A method according to claim 7, 8 or 9 wherein the determining step c) controls the step b) in dependence on factors including the number of times, recorded in the database, instances of the file have been processed.

11. A method according to any one claims 7 to 10, and including the step of updating the database in dependence upon the result of the processing of the file by the step b).

12. A method according to claim 11 wherein the updating of the database, in the event of the step b) determining that the file contains, or is likely to contain, malware is such that the record thereof in the database is deleted, or updated so that it is no longer taken be safe.

13. A system for processing a computer file to determine whether it contains a virus or other malware substantially as hereinbefore described and with reference to the accompanying drawings

14. A method of processing a computer file to determine whether it contains a virus or other malware substantially as hereinbefore described and with reference to the accompanying drawings
